(19) United States
(12) Patent Application Publication
(10) Pub. No.: US 2009/0177842 A1
(43) Pub. Date: Jul. 9, 2009

(54) DATA PROCESSING SYSTEM AND METHOD FOR PREFETCHING DATA AND/OR INSTRUCTIONS

(75) Inventor: Milind Manohar Kulkarni, San Jose, CA (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/280,817

(22) PCT Filed: Feb. 26, 2007
(86) PCT No.: PCT/IB2007/050604

§ 371 Date: Aug. 27, 2008

(30) Foreign Application Priority Data
Feb. 27, 2006 (EP) 06110435.2

(51) Int. Cl. G06F 12/08; G06F 12/00

(52) U.S. Cl. 711/125; 711/129; 711/154; 711/E12.017; 711/E12.001

(57) ABSTRACT

A data processing system for processing at least one application is provided. The data processing system comprises a processor (100) for executing the application. The system furthermore comprises a cache memory (200) being associated to the processor (100) for caching data and/or instructions for the processor (100). The system furthermore comprises a memory unit (400) for storing data and/or instructions for the application. The memory unit (400) comprises a plurality of memory partitions (401-404). Data with similar data attributes are stored in the same memory partition (401-404). A predefined prefetching pattern is associated to each of the memory partitions (401-404).

### FIELD OF THE INVENTION

The present invention relates to a data processing system, a method for prefetching data and/or instructions, a method for loading data and/or instructions into a memory as well as to an electronic device.

### BACKGROUND OF THE INVENTION

Today's data processing systems or processors are based on a certain memory hierarchy, comprising memories with different speeds and sizes. However, as fast memories are expensive, the memory hierarchy is organized into several levels, wherein each level is smaller, faster and more expensive per byte than the next lower level. Usually, all data in one level can also be found in the level below and all data in the lower level can be found in the level below this one until the bottom of the hierarchy is reached.

A cache memory may constitute the first level of the memory hierarchy, i.e. it is the memory closest to a central processing unit CPU or a processing unit. If the CPU requests a data item, which can be found in the cache, a so-called cache hit has occurred. However, if the data item requested by the CPU cannot be found in the cache, a so-called cache miss has occurred. The time needed to correct the cache miss and fetch the requested data item depends on the latency and the bandwidth of the memory. The latency corresponds to the time for retrieving a first word of a block and the bandwidth relates to the time to retrieve the rest of a block. The basic idea of a cache is to fetch those data items, which will be needed during upcoming processing cycles before their actual processing.

The memory bandwidth can be exploited by replacing a whole cache line at a time if a cache miss occurs. However, such an approach will also increase the cache-line size in order to improve the available memory bandwidth. Large cache lines are advantageous in particular with regard to pre-fetching. However, if the size of the cache lines increases, the performance of the system may be decreased if programs do not have sufficient spatial locality and cache misses frequently take place.

In “Dynamically Variable Line-Size Cache Exploiting High On-Chip Memory Bandwidth of Merged DRAM/Logic LSIs” by K. Inoue et al., Proceedings of HPCA-5.5 International Conference on High Performance Computing, January 1999, it is described to change the size of cache-lines at runtime according to the characteristics of an application being currently executed.

Algorithms which may be processed within a data processing system will differ with respect to their locality of reference for the instructions as well as the data. The locality of reference constitutes a property of applications running on a processor. The locality of reference indicates how different memory regions are accessed by the application. Here, the locality of references may refer to the spatial locality of reference and the temporal locality of reference. An application has a good spatial locality of reference if there is a great likelihood that the data locations that are in close proximity of the recently accessed data location will be accessed in near future. Temporal locality of reference indicates that the access to the recent data location will occur again in the near future. Therefore, while some algorithms will have a good locality of reference (either spatial, temporal or both), others comprise a bad locality of reference. Accordingly, some algorithms will have a good cache hit rate while others will have a rather bad cache hit rate. It should be noted that cache misses cannot be avoided. However, the cache miss rate should be reduced to a minimum in order to reduce the cache miss penalty. If the processed data comprise a rich spatial locality, larger cache lines are used.

### SUMMARY OF THE INVENTION

It is an object of the invention to provide a data processing system a method for prefetching data and/or instruction with a reduced amount of cache miss penalty.

This object is solved by a data processing system according to claim 1, a method for loading data and/or instructions into a memory according to claim 5, a method for prefetching data and/or instructions according to claim 6 and an electronic device according to claim 8.

Therefore, a data processing system for processing at least one application is provided. The data processing system comprises a processor for executing the application. The system furthermore comprises a cache memory being associated to the processor for caching data and/or instructions for the processor. The system furthermore comprises a memory unit for storing data and/or instructions for the application. The memory unit comprises a plurality of memory partitions. Data with similar data attributes are stored in the same memory partition. A predefined prefetching pattern is associated to each of the memory partitions.

According to an aspect of the invention, the cache memory comprises a plurality of registers which are each associated to one of the memory partitions of the memory. The registers are used to store the predefined prefetching pattern associated to the memory partitions. Data and/or instructions are prefetched according to the prefetched pattern stored in the registers. Hence, the prefetching of a data item can be customized for the particular data item, in particular regarding its data attributes.

According to a further aspect of the invention, data with a similar locality of reference are stored in the same memory partition. Accordingly, the cache miss penalty can be reduced as only those data items which are required will be prefetched.

According to still a further aspect of the invention, data stored in a memory partition having a high locality of reference are fetched as a complete block of data, merely the requested data stored in the memory partition having a low locality of reference is fetched.

The invention also relates to a method for loading data and/or instructions of an application into a memory unit. The memory unit comprises a plurality of memory partitions. Data and/or instructions with similar data attributes are loaded in the same memory portion. Accordingly, the memory and the data stored therein will be organized according to the data attributes.

The invention furthermore relates to a method for prefetching data and/or instructions of an application from a memory unit, which comprises a plurality of memory partitions. The data from the memory unit is prefetched into a cache memory associated to a processor. Data with similar data attributes are stored in the same memory partition. A predefined prefetching pattern is performed on each of the memory partitions.

The invention also relates to an electronic device for processing an application. The electronic device comprises at least one processor for executing the application. The electronic device furthermore comprises a cache memory associated to at least one of the processors for caching data and/or instructions received from a memory unit having a plurality of memory partitions. Data with similar data attributes are stored in the same memory partition. A predefined prefetching pattern is associated to each of the memory partitions.

The invention relates to the idea to partition a memory space into different regions while instructions and/or data with similar cache performance are placed together in similar regions. The regions may also be based on the amount of words being fetched during a cache miss. Accordingly, by reorganizing the storage of data in the memory, a substantial gain can be achieved. This may lead to a better performance and a reduced execution time.

The embodiments of the invention as well as the advantages thereof are described below in more detail with reference to the drawings.

### BRIEF DESCRIPTION OF THE DRAWINGS

FIG. 1 shows a block diagram of a data processing system,

FIG. 2 shows a representation of a memory partitioning for a memory of FIG. 1, and

FIG. 3 shows a representation of the partitioning of the cache.

### DETAILED DESCRIPTION OF EMBODIMENTS

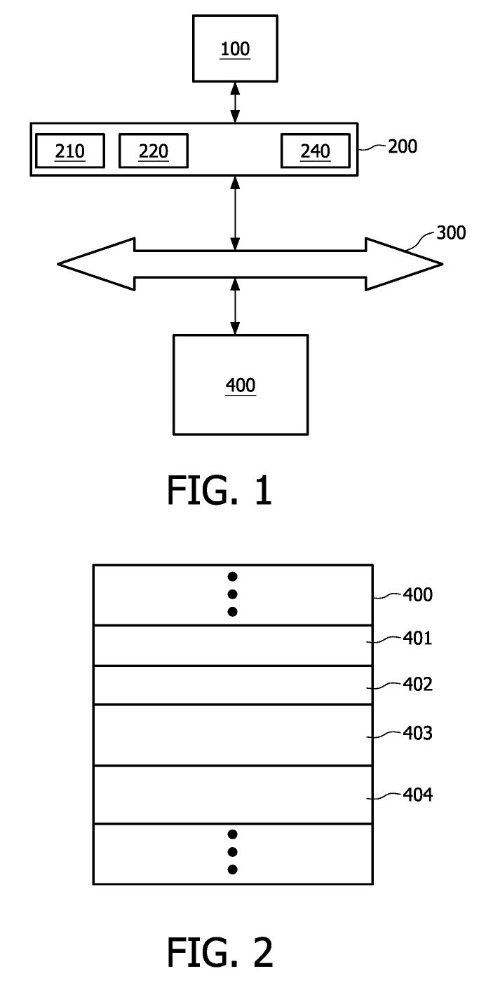

FIG. 1 shows a block diagram of an architecture of a data processing system for processing an application according to a first embodiment. The data processing system comprises a processor 100, a cache 200, a data bus 300 and a memory unit 400. The specific program data and/or the instructions for the application are stored in the memory unit 400. Data and/or instructions from the memory 400 are prefetched to the cache 200 via the bus 300. The cache may comprise a cache controller 210 for controlling the operation of the cache and a cache memory 220. The cache may further comprise configurable registers 240.

FIG. 2 shows a representation of the memory 400 of FIG. 1. In particular, the memory 400 is divided into different regions or areas 401-404 and data and/or instructions for the application is stored in those memory regions 401-404. The data with a similar locality of reference behavior is arranged in the same memory region 401-404. If data does not show any locality of reference, such data is placed in the memory region 401. If this data is accessed, merely one word is fetched and forwarded. For example, the region 404 may contain data and instructions sharing a very good locality of reference. If these data in the memory region 404 are accessed, a full cache block (a cache line, or multiple words) of data is prefetched to the cache 200. Hence, the prefetching of data and/or instructions will depend on where the data is stored, i.e. in which memory region the data is stored. Accordingly, with such an architecture, the penalty of a cache miss is reduced. The locality of reference or the principle of locality concerns the process of accessing a single resource multiple times. The locality of reference may relate to temporal, spatial and sequential locality. Temporal locality of reference relates to the concept that a resource reference at one point in time will be referenced again some time in the near future. The spatial locality of reference relates to the concept that a likelihood of referencing a resource is higher if an adjacent resource has just been referenced. The sequential locality of reference relates to the concept that a memory is accessed sequentially. Therefore, the data is stored in a particular memory region 401-404 according to their temporal, spatial and/or sequential locality of reference. The data to be stored in the memory 400 may be analyzed to determine the locality of reference of the data and to store the data in the respective memory region 401-404 based on their locality of reference.

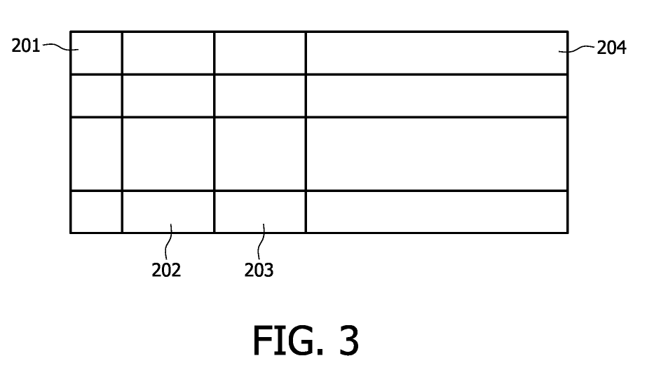

FIG. 3 shows a representation of the partitioning of the cache of FIG. 1. The cache 200 may comprise a cache controller 210 for controlling the operation of the cache as well as a cache memory 220 which may be used to indicate the status of the data within the cache memory. A first cache column 201 is used to indicate the status of the cache block, i.e. whether it is modified, shared, invalid or exclusive. A second cache column 202 is used to indicate the bit status of the data within a cache block. The status can be valid or invalid. A third cache column 203 is used to indicate the tag information as well as further status bits which may be required for implementing various cache mechanisms. A fourth cache column is used to indicate the particular data stored in the cache.

The cache 200 may further comprise of (configurable) registers 240. Preferably, a register is associated to each of the partitions. The register serves to store information with regard to each of the partitions. This information may contain the start and end address, the number of words to be fetched if data or instructions are accessed from such a partition.

The processor 100 will issue a command to the cache 200 requesting to read data from a specified address. If this data is already prefetched into the cache 200, a cache hit will occur and the data is forwarded from the cache 200 to the processor 100. However, if this data is not present in the cache 200, a cache miss will occur. The cache controller 210 of the cache 200 may determine the partition or memory region 401-404 of the address within the memory 400 and issue a fetch operation in order to fetch a number of words which is associated with this partition. The data from the partition or the memory subsystem is then forwarded to the cache 200 according to the predefined prefetching pattern for this region 401-404. The status of the cache block is then updated in order to indicate whether valid data is present in the cache block.

According to the invention, the memory space is partitioned or devided into different memory regions wherein instructions and/or data are placed into one of the memory regions with other instructions and/or data which have a similar cache performance like a similar locality of reference. The memory regions where data is stored indicate the amount of words which will be fetched during a cache miss.

The above described architecture may be implemented in a multi processor system on chip. Accordingly, applications exhibiting a poor spatial locality of reference can be mapped.

The invention also relates to a method for categorizing data and instructions of different behaviors and to create corresponding memory partitions within a memory. According to this information, a linker or a loader application, which load the application object code (binary file) into the system memory during boot-up time, may organize the actual data into the particular memory regions as instructed. Accordingly, a compiler, a linker and/or a loader unit may be provided to enable the above-mentioned categorizing and creation. A predefined prefetching pattern is associated to each of the memory partitions or regions.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

Furthermore, any reference signs in the claims shall not be construed as limiting the scope of the claims.

1. Data processing system for processing at least one application, comprising
at least one processor (10) for executing the at least one application;
a cache memory, associated to the at least one processor, for caching data and/or instructions; and
a memory unit for storing data and/or instructions of the at least one application;
wherein the memory unit comprises a plurality of memory partitions, wherein data with similar data attributes are stored in the same memory partition; and
wherein a predefined prefetching pattern is associated to each of the memory partitions.

2. Data processing system according to claim 1, wherein the cache memory comprises a plurality of registers, each being associated to one of the memory partitions, for storing the predefined prefetching pattern associated to the memory partition,
wherein data and/or instructions are prefetched according to the prefetch pattern stored in the registers.

3. Data processing system according to claim 1, wherein data with a similar locality of reference are stored in the same memory partition.

4. Data processing system according to claim 3, wherein data stored in a memory partition having a high locality of reference are fetched as a complete block of data, wherein merely the requested data stored in a memory partition having a low locality of reference is fetched.

5. Method for loading data and/or instructions of at least one application into a memory unit, wherein the memory unit comprises a plurality of memory portions, comprising the step of:
loading data and/or instructions with similar data attributes in the same memory partition.

6. Method for prefetching data and/or instructions of at least one application from a memory unit having a plurality of memory partitions into a cache memory associated to a processor, wherein data with similar data attributes are stored in the same memory partition comprising the step of:
performing a predefined prefetching pattern associated to each of the memory partitions.

7. Method for prefetching data and/or instructions according to claim 6, wherein data and/or instructions with a similar locality of reference are stored in the same memory partitions, wherein the prefetching pattern depends on the memory region where the data to be prefetched is stored.

8. Electronic device for processing at least one application, comprising:
at least one processor for executing the at least one application; and
a cache memory associated to the at least one processor for caching data and/or instructions from a memory unit having a plurality of memory partitions, wherein data with similar data attributes are stored in the same memory partition, wherein a predefined prefetching pattern is associated to each of the memory partitions.
